(19) United States
(12) Patent Application Publication
(10) Pub. No.: US 2006/0118769 A1
(43) Pub. Date: Jun. 8, 2006

(54) Backer rod installation tool

(75) Inventors: Kal M. Zam, Chino, CA (US); Jeffrey D. Ayotte, Long Beach, CA (US)

Correspondence Address: KELLY LOWRY & KELLEY, LLP, 6320 CANOGA AVENUE, SUITE 1650, WOODLAND HILLS, CA, 91367, US

(73) Assignee: The Slick Company

(21) Appl. No.: 11/005,702

(22) Filed: Dec. 6, 2004

(51) Int. Cl. B66F 13/00

(52) U.S. Cl. 254/1

(57) ABSTRACT

A backer rod installation tool includes a handle and a wheel rotatably attached to an end thereof and adapted to insert backer rod to a desired depth in a joint or gap between building surfaces. The wheel has a smaller cross-sectional diameter towards its attachment to the handle, and a larger cross-sectional diameter away from its attachment to the handle so as to automatically insert the backer rod material from a depth between one-fourth inch (¼″) to one-half the width of the gap or joint. Preferably, an end of the handle generally offset the wheel is tapered so as to push the backer rod material into the joint or gap at the proper depth.

### BACKGROUND OF THE INVENTION

The present invention generally relates to backer rods and caulking. More particularly, the present invention resides in a backer rod insertion tool.

Buildings often have numerous lengthy joints or gaps between the various building surfaces. To seal out moisture from joints, cracks, crevices, and the like, such cracks and crevices are filled with caulking material. In larger cracks and crevices, such as around a newly installed window, door, or other crevices, a backer rod is inserted in the gap or crevice as a preliminary step before caulking. If the joint or crack to be sealed is one-fourth inch (¼″) wide or wider, it is usually best to install the foam backer rod in the joint to the proper depth before applying the caulking material.

Backer rod is generally cheaper than a good quality caulking compound, and most of the joints should be filled with the backer rod before the actual sealant is installed. The proper installation of the backer rod also provides an “hour class” cross-sectional shape to the bead of sealant. This provides a larger surface area of adhesion to be established on the sides of the joint, while a relatively thin cross-section of sealant is left in the center of the joint to allow for easy flexing to handle the inevitable joint movement. It also provides a “bond-breaking” surface at the rear of the joint or crack that prevents the sealant from early failure.

Building specifications require the installation of the backer rod at a pre-determined depth depending on the width of the joint. Typically, backer rod is desirably inserted in the recess to the depth that will allow the thickness of the sealant to be approximately one-half that of the width of the joint.

A problem in the past has been the placement of the backer rod at the appropriate depth. Backer rod is used to control the depth of sealant. Installing the backer rod too deep or too shallow will render the sealing job virtually worthless.

In the past, many construction workers have manually installed backer rod using a putty knife, spatula, stick, etc. However, use of a putting knife, spatula, stick, etc., renders it very difficult to insert the backer rod at the proper depth. Moreover, such tools present sharp edges or points which can damage the surface of the backer rod, such as nicking or poking holes in the backer rod material. Wherever such damage occurs, there is a risk of “out-gassing” from the backer rod and forming blisters in the sealant. Although, open-cell backer rod material does not have this problem, it has a much greater tendency to absorb water and hold it, with a potentially very negative effect on the sealant if the integrity of the sealant is breached at a later date. A further problem of using such hand tools is that many buildings have hundreds, or even thousands of linear feet of joints and gaps the require backer rod installation. Utilizing these tools requires an inordinate amount of time for the installation of the backer rod to the predetermined depth.

U.S. Pat. No. 5,058,254 discloses a tool for inserting backer rods. It is comprised of a plurality of wheels attached to a frame, having an extension which can be held by the construction worker. While addressing adequately the problem of inserting backer rods in a quick manner along gaps and crevices of a substantially constant width, it presents various problems in its operation if the width of the gap changes. The tool requires two or more wheels which must be manually adjusted according to the width of the gap into which the backer rod is being inserted. At times, the wheel of the tool must be replaced with another wheel to finish the job along the same gap. Moreover, the use of the device is fairly complicated and time consuming.

Accordingly, there is a continuing need for a backer rod insertion tools so as to overcome the aforementioned disadvantages. The present invention fulfills this need and provides other related advantages.

### SUMMARY OF THE INVENTION

The present invention resides in a tool for installing a sealant backer rod. The tool of the present invention does not require continual adjustment while inserting the backer rod along a gap having a varying width. Nor does the tool require the use of multiple wheels or the like.

The tool generally comprises a handle having a gripping portion and a wheel rotatably attached to an end thereof. The wheel is adapted to automatically insert backer rod to a desired depth in the joint or gap between building surfaces. In particular, the wheel has a smaller cross-sectional diameter toward the attachment to the handle and a larger cross-sectional diameter away from its attachment to the handle. Typically, the wheel tapers from the attachment point of the handle away from the handle. This enables the wheel to automatically adjust and insert the backer rod material to a depth of between one-fourth inch (¼″) to one-half the width of the gap.

Preferably, the construction worker's hand is moved away from the building surface material, such as a stucco wall or the like to avoid scratching his or her knuckles. Accordingly, the wheel may disposed at an offset angle to the handle. Alternatively, the end of the handle attached to the wheel is of a reduced diameter. In yet another embodiment, the end of the handle attached to the wheel is angularly off-set from the gripping portion thereof.

In some instances, it is desirable to utilize a wheel having a relatively large cross-sectional diameter at a central portion thereof, and a smaller cross-sectional diameter towards the opposite ends. Typically, the wheel tapers from the central portion to the opposite end thereof. When utilizing such wheels, a handle having arms extending from an end thereof to form a general U-shaped configuration may be used, wherein opposite ends of the wheels are attached to each arm.

Preferably, an end of the handle generally opposite the wheel is tapered at an angle so as to push the backer rod into the joint or gap. The tapered angle insures the proper depth of insertion.

In another embodiment, the end of the handle, generally opposite the wheel, includes means for attaching an extension handle thereto.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective environmental view illustrating an end of a tool embodying the present invention installing backer rod into a gap between building surfaces;

FIG. 2 is a perspective environmental view illustrating the insertion of backer rod into a gap between building surfaces using an opposite end of tool of FIG. 1, and having a wheel adapted for insertion of the backer rod into the gap;

FIG. 3 is a cross-sectional view illustrating the placement of backer rod to a desired depth between building materials;

FIG. 4 is a cross-sectional view similar to FIG. 3, but illustrating the insertion of a larger backer rod into a larger joint;

FIG. 5 is a side elevational view of a backer rod insertion tool embodying the present invention;

FIG. 6 is a cross-sectional view taken generally along lines 6-6 of FIG. 5, illustrating rotatable connection of a wheel to the handle of the tool;

FIG. 7 is a side elevational view of another backer rod insertion tool embodying the present invention;

FIG. 8 is a side elevational view of another backer rod insertion tool embodying the present invention;

FIG. 9 is a side elevational view of yet another backer rod insertion tool embodying the present invention;

FIG. 10 is a side elevational view of a wheel used in accordance with the present invention;

FIG. 11 is a is a side elevational view of another wheel used in accordance with the present invention;

FIG. 12 is a side elevational view of yet another wheel embodying the present invention;

FIG. 13 is a side elevational view of another wheel used in accordance with the present invention;

FIG. 14 is a top plan view of a backer rod insertion tool embodying the present invention;

FIG. 15 is a cross-sectional view taken generally along line 15-15 of FIG. 14, illustrating rotational attachment of a wheel tool to a handle of the tool;

FIG. 16 is a top plan view of another wheel used in accordance with the present invention;

FIG. 17 is a top plan view of another wheel used in accordance with the present invention;

FIG. 18 is a top plan view of another wheel used in accordance with the present invention; and

FIG. 19 is a top plan view of yet another wheel used in accordance with the present invention.

### DETAILED DESCRIPTION OF THE PREFERRED EMBODIMENTS

As shown in the accompanying drawings for purposes of illustration, the present invention resides in a backer rod insertion tool which is used to automatically insert backer rods to a desired depth, depending on gap or joint width, as will be more fully discussed herein.

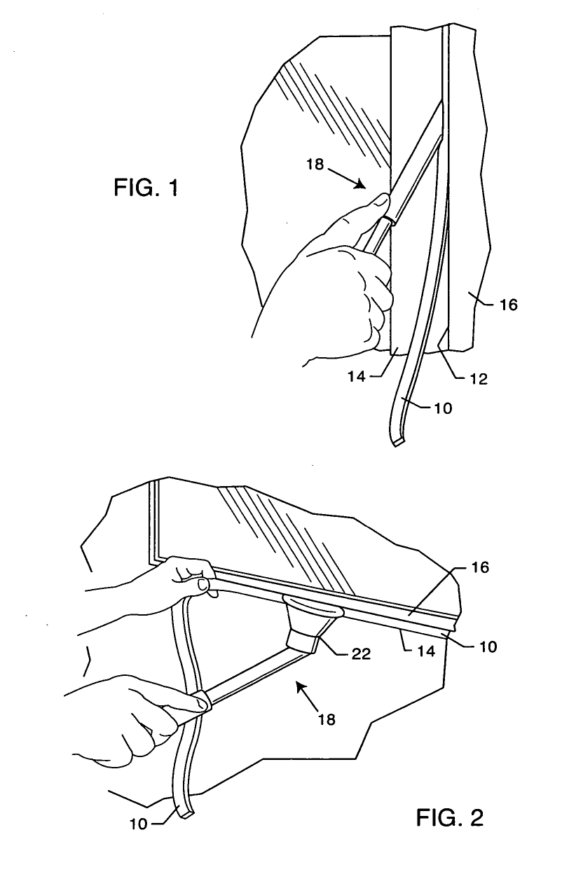

With reference now to FIGS. 1 and 2, as described above, it is often desirable to insert backer rod 10 within a joint or gap 12 between two building surfaces 14 and 16. Such joints or gaps 12 surround windows, doors, and many other instances in a building.

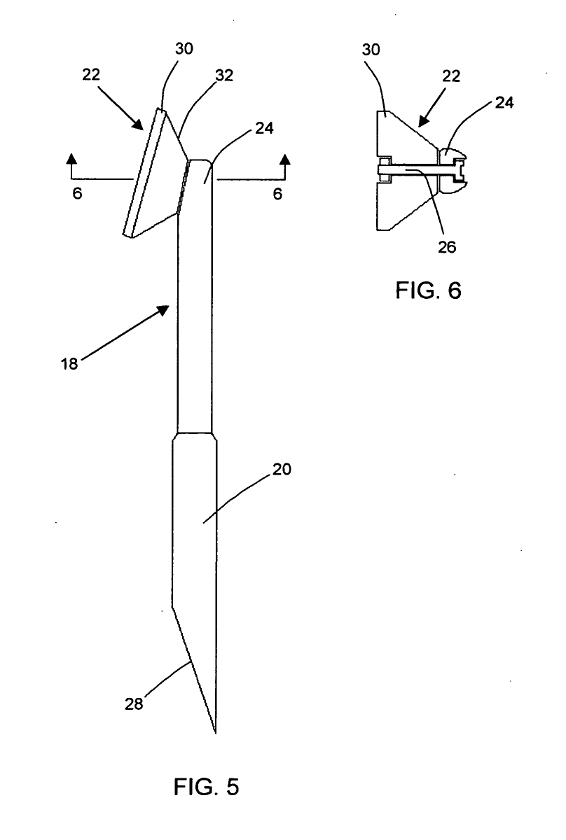

The present invention resides in a backer rod insertion tool, such as the tool 18 illustrated in FIG. 5. The tool 18 includes a handle grip portion 20 which is grasped by the user, as illustrated in FIG. 2. A wheel 22 is rotatably attached to an end 24 of the handle. As illustrated in FIG. 6, the wheel 22 includes an aperture therethrough through which is inserted a bolt, pin or the like 26 which acts as an axle and fastener to the end 24 of the handle.

The wheel 22 may have a lip 30 that is beveled and adapted to contact the backer rod 10. In a particularly preferred embodiment, as illustrated in FIGS. 2-6, the wheel 22 has a cross-sectional diameter which is less towards the handle 20 and greater away from the handle. In particular, the wheel 22 preferably includes a tapered surface 32.

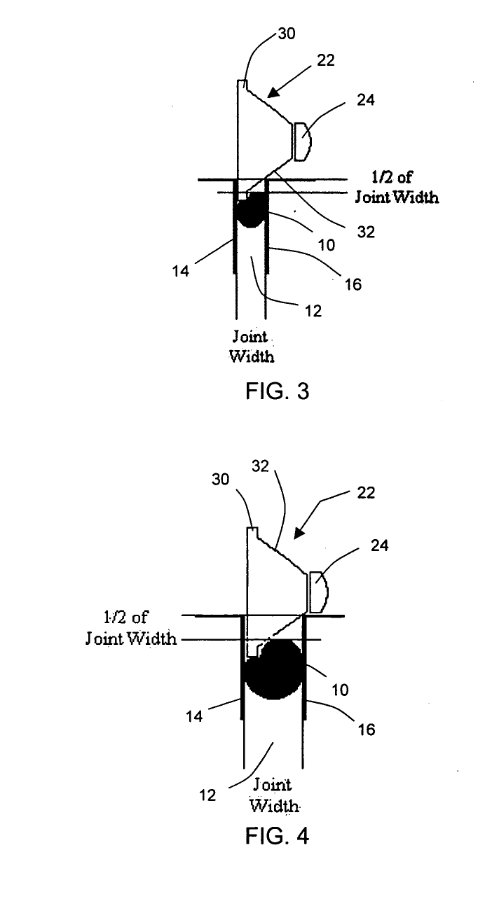

With reference now to FIGS. 3 and 4, operation of the present invention is illustrated. In FIG. 3, where the joint 20 width is fairly narrow, only the lip 30 or outer portion of the tapered surface 32 contacts the backer rod material 10. In FIG. 4, the joint width 12 is greater. Thus, the backer rod material 10 is installed at a greater depth. This is done automatically, due to the special tapered surface 32 of the wheel 22. For example, if the joint 12 width in FIG. 3 were one-half inch (½″), the backer rod material 10 would be inserted approximately one-fourth inch (¼″) deep. Perhaps only the lip 30 or outer surface of the wheel 22 would contact the backer rod material 10. However, assuming the joint 12 width in FIG. 4 were one inch (1″), the backer rod material 10 would need to be installed one-half inch (½″) deep. Thus, the wheel 22 extends farther into the joint gap 12 such that not only does the lip 30, but also a greater amount of the tapered surface 32 contacts the backer rod material 10 so as to insert it at that depth.

Sealant manufacturers recommend that the backer rod be inserted at a 2:1 width to depth ratio for joints ranging from one-fourth inch (¼″) to one inch (1″) widths. A minimum of one-fourth inch (¼″) is recommended by sealant manufacturers. Due to the tapered surface 32 of the wheel 22, the wheel 22 automatically extends into the joint or gap 12 increasingly as the joint or gap 12 width increases. This takes into account irregularities in the width of the joint 12 along the length of the joint, which is common. In the prior art, those using a putting knife or spatula would have to guess the proper depth. Utilizing the device of U.S. Pat. No. 5,058,254 requires constant manual adjustment of the center wheel so as to achieve the proper depth as the joint width 12 increases and decreases.

With reference now to FIG. 5, an end 28 of the handle 20 generally opposite the wheel 22 may be tapered. The taper is at an angle which will set the backer rod material 10 to the desired depth, given a particularjoint 12 width. Thus, with a given taper or angle, the end 28 of the handle 20 can be used to begin insertion of the backer rod material, as illustrated in FIG. 1, or to insert the backer rod material around corners and the like. However, along the length of the joint, the handle 20 is generally held with the wheel 22 in contact with the backer rod material 10 so as to automatically insert and install the backer rod material 10 within the joint 12 at the proper depth, as illustrated in FIG. 2.

Many times, the building surface adjacent to the joint 12 is very rough, such as exterior stucco walls, unfinished wood, etc. Thus, the tool of the present invention is configured to dispose the user's hand away from the working surface. The tool 18 illustrated in FIG. 5 has the wheel 22 connected to the handle 20 in an offset angled manner. This causes the hand to be positioned away from the building material 14, as illustrated in FIG. 2.

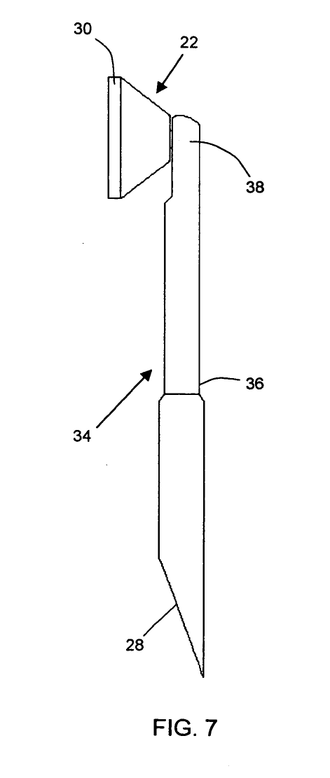

With reference now to FIG. 7, a tool 34 is illustrated having a handle 36 wherein the end of the handle 38 attached to the wheel 22 is of reduced cross-sectional diameter such that the user's hand is disposed away from the working surface while the wheel 22 is free to enter the gap or joint 12 to the extent necessary.

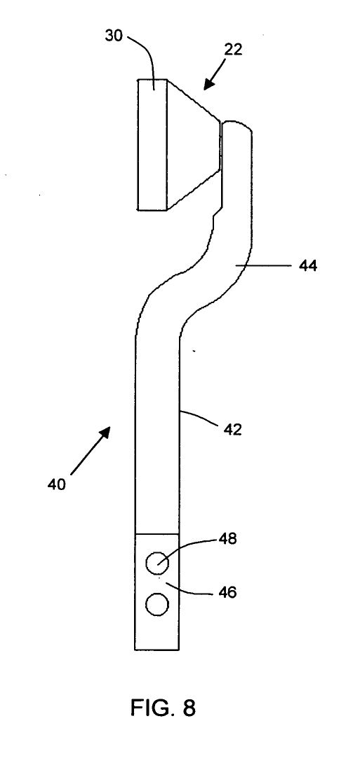

With reference now to FIG. 8, another tool 40 is illustrated wherein the handle 42 has a portion 44 which is angularly offset from the grippable portion 42 of the handle and to which is attached the rotatable wheel 22. Such a design can accommodate instances where there are raised building materials surrounding the gap 12 or the like.

The handle 42 in the embodiment illustrated in FIG. 8 also includes an end 46 having means for attaching an extension handle thereto. As illustrated, the means comprise apertures 48 through which a screw or bolt can be inserted for attachment to an extension handle. It will be appreciated by those skilled in the art that the fastening means are not limited to such, but can include, for example, internal threads within the handle 42 which receive an externally threaded end of an extension handle, such as a broom stick and the like. It will be further understood by those skilled in the art that the extension handle (not shown) could include the tapered end 28, as illustrated and described above. Alternatively, or additionally, the tapered end 28 could be removably attached to the handle and the extension handle attached to a free end of the handle 20 or 36 such that the tapered end 28 could be easily used by the construction worker and placed in his or her tool pouch, pocket or the like.

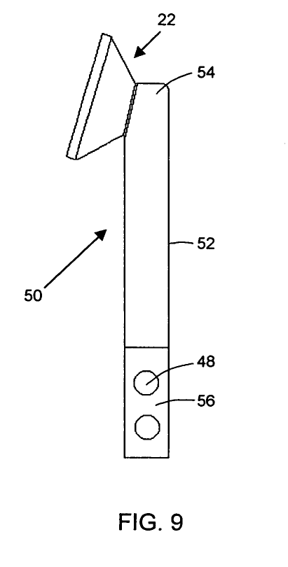

With reference to FIG. 9, a tool 50 is illustrated having a generally straight handle 52, similar to that illustrated in FIG. 5, with the wheel 22 angularly offset or the wheel 22 attached to an end 54 thereof in an angularly offset and rotatable manner, but having the opposite end 56 including attachment means 48 as described above. Thus it will be appreciated by those skilled in the art that the tool of the present invention can be varied to incorporate any necessary handle design.

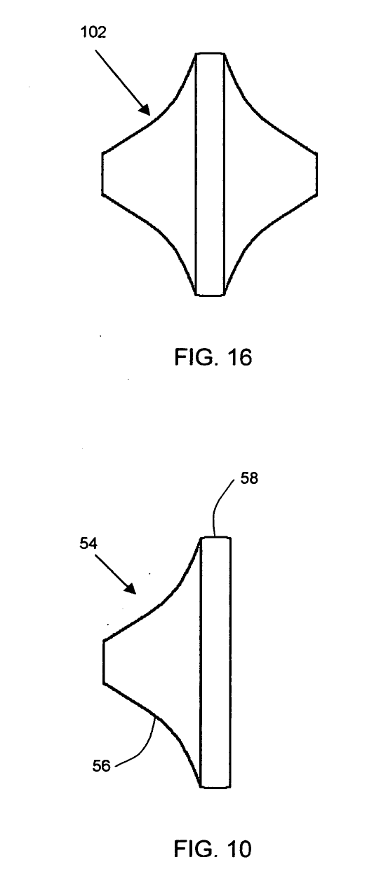

With reference now to FIG. 10, a wheel 54 is illustrated which can be used in association with any of the foregoing illustrated and described handles. As shown in the illustration, the tapered surface 56 thereof greatly increases towards the end of the wheel, resulting in the lip 58 of the wheel 54 being inserted fairly deeply into the joint. It will be appreciated by that the lip 30 or 58 can be of differing diameters depending upon the intended use of the wheel 22 or 54.

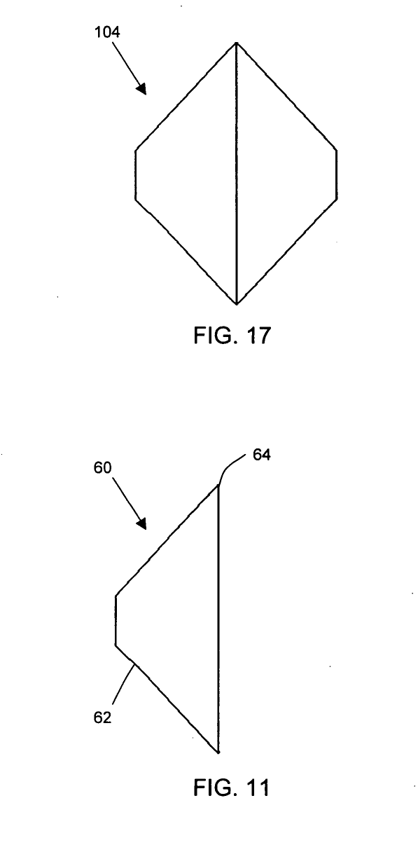

With reference now to FIG. 11, yet another wheel 60 is illustrated. This wheel 60 has no beveled lip whatsoever, but instead the tapered surface 62 extends out at a fairly constant angle to a relatively sharp edge 64, which could be considered a lip.

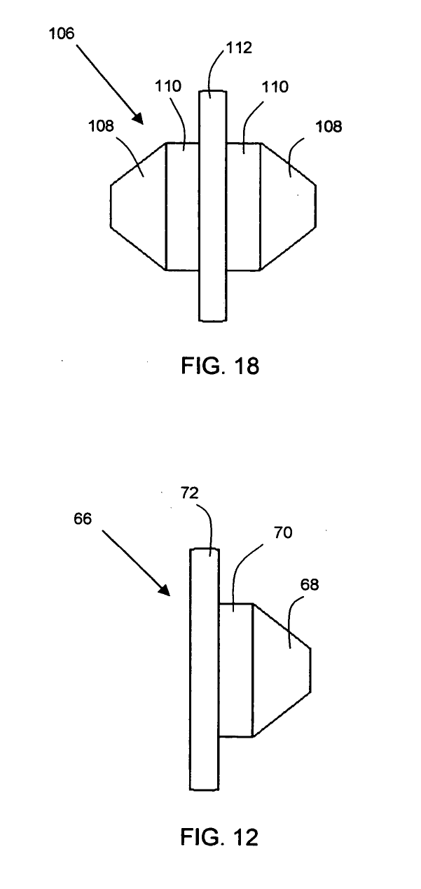

With reference now to FIG. 12, yet another wheel 66 is illustrated. At the end 68 adjacent to the attachment of the handle is a tapered surface 68. A non-tapered ledge 70 is disposed intermediate the tapered surface 68 and a lip 72. The lip is of a predetermined width and has a predetermined height or extension beyond the intermediate ledge 70. For example, the lip 72 can extend one-fourth inch (¼″) from the intermediate bevel 70 so as to insert the backer rod material 10 one-fourth inch (¼″) into the gap. The combined width of the lip 72 and intermediate bevel 70 could be, for example, one-fourth inch (¼″) such that so long as the gap 12 width were one-fourth inch (¼″) or less, the backer rod would be inserted one-fourth inch (¼″) deep. However, if the width of the gap or joint 12 were to increase beyond one-fourth inch (¼″) the tapered surface 68 would cause the lip 72 to extend further into the joint 12 to push the backer rod material to a corresponding depth approximately equal to one-half the width of the joint 12.

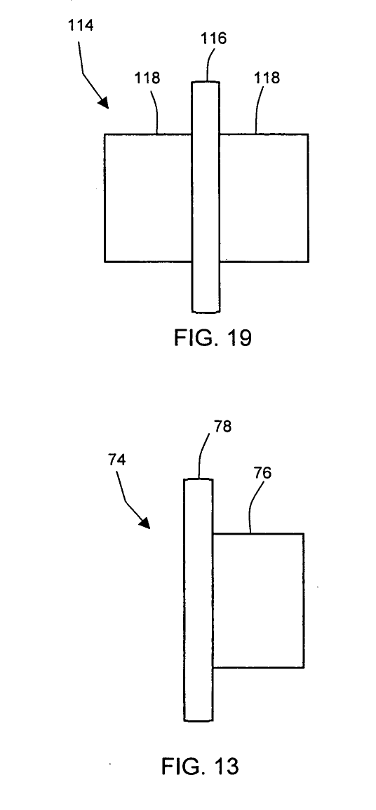

With reference now to FIG. 13, yet another wheel 74 is illustrated. This wheel 74 includes an area 76 adjacent to the attachment point of the handle of one cross-sectional diameter, and a lip or other portion 78 of the wheel of increased cross-sectional diameter. Similar to that of the wheel 66 of FIG. 12, the extension of the lip or portion 78 from the lower portion 76 creates a constant backer rod insertion depth. This wheel 74 can be used, for example, when a constant backer rod depth is desirable or when the joint width is fairly constant, such as in industrial floors and the like. For example, the lip 78 can extend outwardly one-half inch (½″) from the lower portion 76 such that the backer rod material is inserted at a depth of one-half inch (½″) in the joint 12, regardless of the width of the joint.

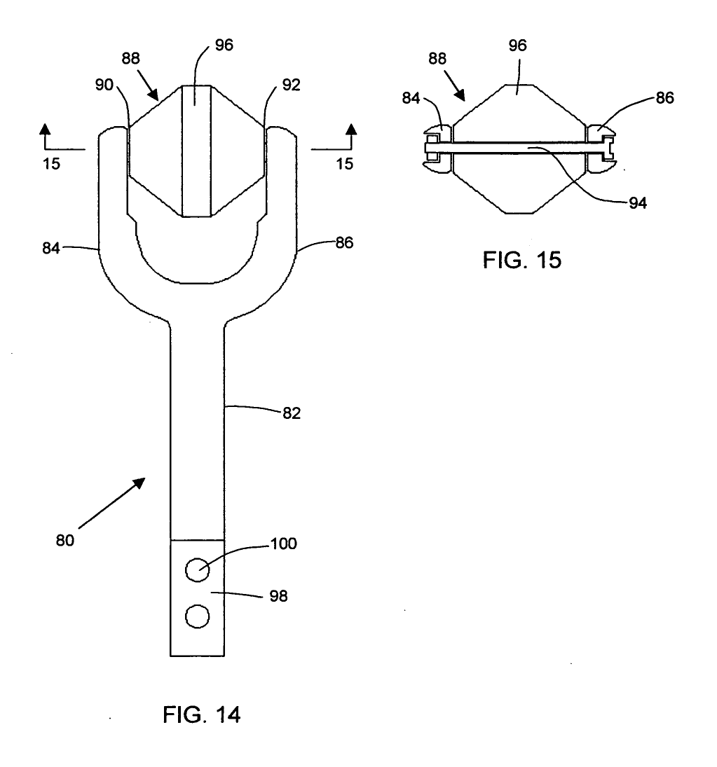

With reference now to FIG. 14, yet another tool 80 is illustrated. This tool 80 has a handle 82 having a gripping portion and arms 84 and 86 extending from an end thereof in spaced apart fashion to form a generally U-shape configuration. A wheel 88 has opposite ends 90 and 92 thereof attached to the respective arms 84 and 86. As illustrated in FIG. 15, a pin, bolt or other appropriate attachment means extends through the wheel 88 for rotatable attachment to the arms 84 and 86 of the handle 82. The wheel 88 has a central width or portion 96 of greatest cross-sectional diameter. The wheel 88 tapers from the central portion 96 towards the ends 90, 92 thereof as illustrated. This dual taper design is specifically intended for use in generally flat applications, such as when installing backer rod on a flat surface such as a floor or the like. An opposite end of the handle 98 includes means 100, such as the illustrated apertures for attaching an extension handle or the like such as that user, instead of being on his hands or knees, can stand erect and with a several foot extension can properly install the backer rod 10 into the gap before sealing the joint. Of course, the handle 82 can be provided of a length sufficient so as to enable the worker to stand erect, or reach elevated joints or the like. Once again, the tapered nature of the wheel 88 accommodates differences in the width of the gap along the joint 12. This is particularly useful, for example, when filling in gaps of metal works or the like which may not be precisely machined.

Although the wheel 88 having the dual tapered design is illustrated as being connected to the handle 82 of tool 80, it will be understood that the wheel 88 could be attached to any of the previously described and illustrated handles 20, 36, 42 or 52 and perform generally adequately. Of course, a longer pin or bolt 94 would be necessary to rotatably attach the wheel 88 to the handle.

With reference now to FIG.16 and 17, other wheels 102 and 104 are illustrated of dual taper design for use as needed.

With reference now to FIG. 18, a wheel 106 is illustrated having dual or mirror-image design similar to that of FIG. 12 and achieving the same purposes as that of the wheel 66 of FIG. 12, but adapted to be installed on the handle 82 illustrated in FIG. 14. As such, the wheel 106 includes opposing tapered surfaces 108, a ledge 110 and a central lip portion 112. The distance between the outer edge of the lip 112 and the ledge 110 dictate the depth that the backer rod is installed so long as the width of gap does not exceed the combined width of the central lip portion 112 and adjacent ledges 110. This automatically keeps the backer rod depth at an intended depth, such as one-half inch (½″), unless the width of the gap varies dramatically.

With reference now to FIG. 19, yet another wheel 114 is illustrated having a central raised portion or lip 116 and adjacent areas 118 of reduced cross-sectional diameter. Once again, similar to the wheel 74 illustrated in FIG. 13, this is particularly useful in -industrial floors or the like where the same depth is desired regardless of the gap or joint 12 width. That is, the distance from the outer edge of the central portion or lip 116 to the adjacent portions 118 dictates the depth that the backer rod is installed. Once again, this wheel 114 can be attached to the handle 82 of FIG. 14 or any of the other handles illustrated and described above.

In use, as illustrated in FIGS. 1 and 2, the backer rod 10 is first inserted in the gap 12 using the pointed or the tapered end 28 of the handle, generally opposite the wheel, as illustrated in FIG. 1. Due to the selected tapered angle, the backer rod 10 is automatically set to the proper depth. The user then grasps the handle and depresses the wheel 22 against the backer rod 10 to insert it into the joint 12 of the working surface, as illustrated in FIG. 2. Upon reaching the corner, the construction worker uses the end of the handle 28 opposite the wheel 22 to push the backer rod 10 around the corner of the joint 12. As discussed above, the prior art device of the '254 patent requires a different tool or the changing of the wheels of the tool in order to accommodate such corners. The user can insert the backer rod 10 with a single hand, as illustrated in FIG. 2. It has been found by the inventors that the use of the tool of the present invention can reduce the time and labor of the insertion of backer rod 10 by three-fold. Use of the tool of the present invention is intuitive and very easy. There is no need for manual adjustment during the insertion of the backer rod 10. Once the user has selected the appropriate handle and wheel, the steps taken in the accompanying drawings, as discussed above, can accomplish any backer rod installation job in preparation of caulking and sealing.

Although several embodiments have been described in detail for purposes of illustration, various modifications may be made to each without departing from the scope and spirit of the invention. Accordingly, the invention is not to be limited, except as by the appended claims.

What is claimed is:

1. A tool for installing a sealant backer rod, comprising:
a handle; and
a wheel rotatably attached to an end of the handle and adapted to insert backer rod to a desired depth in a joint or gap between building surfaces;
wherein the wheel has a smaller cross-sectional diameter towards its attachment to the handle and a larger cross-sectional diameter away from its attachment to the handle.

2. The tool of claim 1, wherein the wheel tapers outwardly from the handle.

3. The tool of claim 1, wherein the wheel is configured to adjust the depth of the backer rod to between ¼″ to one-half of the width the of the gap or joint.

4. The tool of claim 1, wherein the wheel is disposed at an offset angle to the handle.

5. The tool of claim 1, wherein the end of the handle attached to the wheel is of reduced diameter.

6. The tool of claim 1, wherein the end of the handle attached to the wheel is angularly offset from a gripping portion of the handle.

7. The tool of claim 1, wherein the opposite ends of the wheel have a smaller cross-sectional diameter than a cross-sectional diameter of a central portion of the wheel.

8. The tool of claim 7, wherein the wheel tapers from the central portion to the opposite ends thereof.

9. The tool of claim 7, wherein the central portion of the wheel defines a backer rod engaging lip.

10. The tool of claim 7, wherein the end of the handle attached to the wheel has arms extending therefrom to form a generally U-shaped configuration, and wherein the opposite ends of the wheel are attached to each arm.

11. The tool of claim 1, wherein an end of the handle generally opposite the wheel is tapered so as to push backer rod into the joint or gap.

12. The tool of claim 1, wherein an end of the handle generally opposite the wheel includes means for attaching an extension handle thereto.

13. A tool for installing a sealant backer rod, comprising:
a handle; and
a wheel rotatably attached to an end of the handle and adapted to insert backer rod in a joint or gap between building surfaces;
wherein the wheel is tapered so as to have a smaller cross-sectional diameter towards its attachment to the handle and a larger cross-sectional diameter away from its attachment to the handle, whereby the backer rod is inserted in the joint to a depth of between ¼″ to one-half the width of the gap.

14. The tool of claim 13, wherein the wheel is disposed at an offset angle to the handle.

15. The tool of claim 13, wherein the end of the handle attached to the wheel is of reduced diameter.

16. The tool of claim 13, wherein the end of the handle attached to the wheel is angularly offset from a gripping portion of the handle.

17. The tool of claim 13, wherein an end of the handle generally opposite the wheel is tapered so as to push backer rod into the joint or gap.

18. The tool of claim 13, wherein an end of the handle generally opposite the wheel includes means for attaching an extension handle thereto.

19. The tool of claim 13, wherein the opposite ends of the wheel have a smaller cross-sectional diameter than a cross-sectional diameter of a central portion of the wheel.

20. The tool of claim 19, wherein the wheel tapers from the central portion to the opposite ends thereof.

21. The tool of claim 19, wherein the central portion of the wheel defines a backer rod engaging lip.

22. The tool of claim 19, wherein the end of the handle attached to the wheel has arms extending therefrom to form a generally U-shaped configuration, and wherein the opposite ends of the wheel are attached to each arm.
